(19) United States
(12) Patent Application Publication
(10) Pub. No.: US 2017/0227448 A1
(43) Pub. Date: Aug. 10, 2017

(54) IMAGE-PROCESSING METHOD AND CELL-SORTING METHOD

(71) Applicant: OLYMPUS CORPORATION, Tokyo (JP)

(72) Inventor: Jun FUNAZAKI, Tokyo (JP)

(73) Assignee: OLYMPUS CORPORATION, Tokyo (JP)

(21) Appl. No.: 15/497,985

(22) Filed: Apr. 26, 2017

Related U.S. Application Data
(63) Continuation of application No. PCT/JP2014/079084, filed on Oct. 31, 2014.

(51) Int. Cl. G01N 15/14; G06T 5/00; G06K 9/00

(52) U.S. Cl. CPC G01N 15/1463; G06K 9/00134; G06T 5/001; G01N 2015/1465; G01N 2015/149; G01N 2015/1006

(57) ABSTRACT

Provided is an image-processing method including: an image-acquiring step of acquiring a divided-section image that includes the entire divided section by capturing an image of a chip array obtained by dividing a substrate into numerous chips together with a section of biological tissue on the substrate; a chip-recognizing step of recognizing chip images in the divided-section image; an attribute-information assigning step of assigning, to each of pixels that constitute the images of the recognized chips, positional information of the chip images to which those pixels belong in the image of the chip array; and a restoring step of generating a restored section image in which images of the divided section are joined into a single image by joining the chip images constituted of the pixels to which the positional information has been assigned.

### CROSS-REFERENCE TO RELATED APPLICATIONS

This is a continuation of International Application PCT/JP2014/079084 which is hereby incorporated by reference herein in its entirety.

### TECHNICAL FIELD

The present invention relates to an image-processing method and a cell-sorting method.

### BACKGROUND ART

In the related art, there is a known method of collecting cells in a specific region of a section of biological tissue by attaching the section to a substrate bonded on a sheet, by dividing the substrate into numerous chips together with the section by stretching the sheet, and by collecting a certain chip from the sheet (for example, see Patent Literature 1). In Patent Literature 1, two sections are cut out from adjacent positions in the biological tissue, one of which is divided together with the substrate by using the above-described method, and the other of which is stained. Then, the region to be harvested in the section is determined on the basis of a stained-section image, and the chip at a position corresponding to the determined region is collected.

### CITATION LIST

### Patent Literature

{PTL 1} PCT International Publication No. WO 2012/066827

### SUMMARY OF INVENTION

A first aspect of the present invention is an image-processing method with which an image of a chip array in which numerous chips, which are obtained by dividing a substrate to which a section of biological tissue is attached together with the section, are two-dimensionally arrayed with spaces between the chips, the image-processing method including: an image-acquiring step of acquiring a divided-section image that includes the entire divided section by capturing an image of the chip array; a chip-recognizing step of recognizing chip images in the divided-section image acquired in the image-acquiring step; an attribute-information assigning step of assigning, to each of pixels that constitute the chip images recognized in the chip-recognizing step, attribute information that includes positional information of the chip images to which those pixels belong in the image of the chip array; and a restoring step of generating a restored section image in which images of the divided section are joined into a single image by joining the chip images constituted of the pixels to which the attribute information has been assigned in the attribute-information assigning step.

### BRIEF DESCRIPTION OF DRAWINGS

FIG. 1 is an overall configuration diagram of a cell-sorting system for executing a cell-sorting method according to an embodiment of the present invention.

FIG. 2A is a diagram showing a substrate and sections before being divided, which are to be used in the cell-sorting system in FIG. 1.

FIG. 2B is a diagram showing the substrate and the sections in FIG. 2A after being divided.

FIG. 3 shows a flowchart showing an image-processing method and the cell-sorting method according to the embodiment of the present invention.

FIG. 4 shows an example of a divided-section image acquired in an image-acquiring step.

FIG. 5 shows an example of a restored section image generated in a restoring step.

FIG. 6 shows a flowchart showing a modification of the image-processing method and the cell-sorting method in FIG. 3.

FIG. 7 shows an example of a restored section image to which color correction has been applied in a color-correcting step.

### DESCRIPTION OF EMBODIMENT

A cell-sorting method according to an embodiment of the present invention will be described below with reference to the drawings.

First, a cell-sorting system 1 for executing the cell-sorting method according to this embodiment will be described.

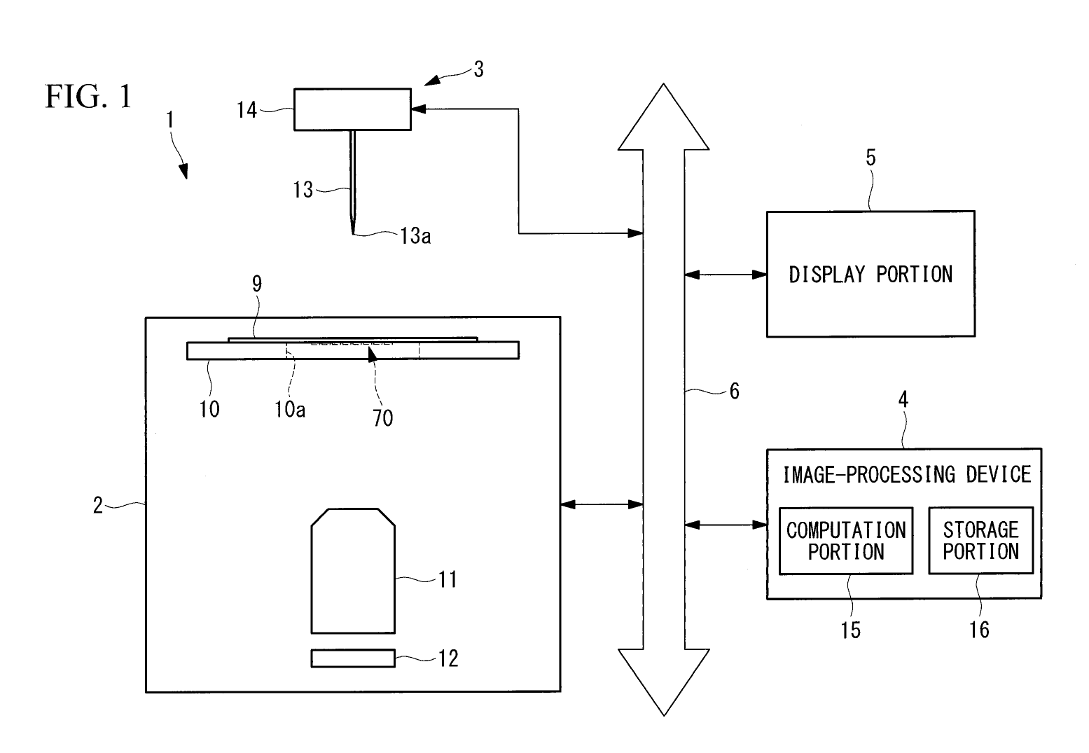

The cell-sorting system 1 is a system for harvesting a specific region containing desired cells from a section A of biological tissue and is provided with, as shown in FIG. 1: an inverted optical microscope 2 having a horizontal stage 10; a punching portion 3 provided above the stage 10; an image-processing device 4 that processes images acquired by the optical microscope 2; a display portion 5; and a data bus 6 that connects these components with each other.

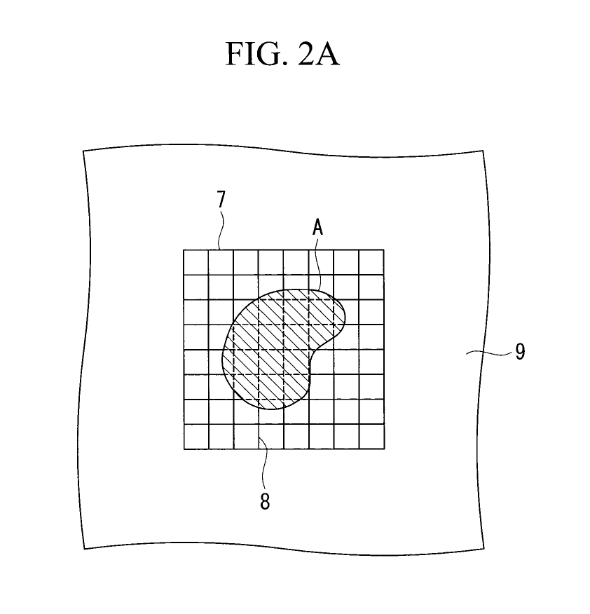

As shown in FIG. 2A, the section A to be used in the cell-sorting system 1 is attached on a thin substrate 7, such as a cover glass. On the surface of the substrate 7, grooves 8 are formed in a grid so that the depth thereof reaches an intermediate position of the thickness of the substrate 7. The spacing between the adjacent grooves 8 is 0.2 mm to 2.0 mm, preferably 0.3 mm to 1.0 mm, and more preferably 0.3 mm to 0.5 mm.

The back side of the substrate 7 is made to adhere, by using an adhesive, on a sheet 9 (for example, a dicing sheet) having elasticity along the surface direction. By stretching this sheet 9 along the surface direction, it is possible to divide the substrate 7 into numerous small rectangular chips 7a along the grooves 8, as shown in FIG. 2B. At this time, the section A on the substrate 7 is also divided into numerous small pieces along the grooves 8 together with the substrate 7. By doing so, as shown in FIG. 2B, a chip array 70 formed of the numerous chips 7a that are in square array with spaces between them is created.

The optical microscope 2 is provided with, below the stage 10, an objective lens 11 with which a specimen on the stage 10 is observed in a magnified form, and an image-acquisition portion 12, such as a digital camera, that captures specimen images acquired by the objective lens 11. In addition, the stage 10 has, at a substantially center portion thereof, a window 10a that passes therethrough in the vertical direction. As shown in FIG. 1, by placing the sheet 9 on the stage 10 so that the chip array 70 is positioned in the window 10a and so that the surface on which the chip array 70 is formed faces downward, it is possible to observe the chip array 70 from the underside of the stage 10 by using the objective lens 11 and to capture an image of the chip array 70 acquired by means of the objective lens 11 by using the image-acquisition portion 12.

The punching portion 3 is provided with a needle 13 and a holder 14 that holds the needle 13 so that a needle tip 13a points downward and that can be moved in the horizontal direction and the vertical direction. By moving the holder 14 in the horizontal direction, the needle tip 13a can be aligned in the horizontal direction with respect to the chips 7a on the stage 10. In addition, by lowering the holder 14 in the vertical direction, it is possible to pierce one of the chips 7a on the back side thereof, to peel the chip 7a off from the sheet 9, and to drop the chip 7a off.

The image-processing device 4 is, for example, a computer, and is provided with a computation portion 15, such as a CPU (central processing unit), and a storage portion 16, such as a ROM (Read Only Memory), that stores an image-processing program. In addition, the image-processing device 4 is provided with an input device (not shown), such as a keyboard, a mouse, or the like, with which a user performs inputs to the image-processing device 4.

The image-processing device 4 stores a-divided-section image P received from the optical microscope 2 in a temporary storage device (not shown) such as a RAM, generates a restored section image Q from the divided-section image P by executing the image-processing program stored in the storage portion 16, and outputs the generated restored section image Q to the display portion 5 to be displayed thereon.

Next, a cell-sorting method employing the cell-sorting system 1 will be described.

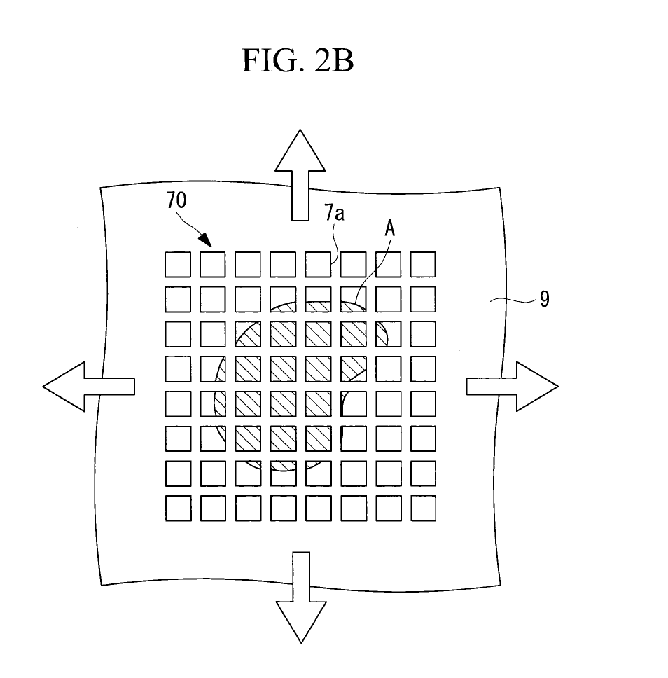

As shown in FIG. 3, the cell-sorting method according to this embodiment includes: an image-acquiring step S1; a template-creating step S2; a chip-recognizing step S3; an attribute-information assigning step S4; a restoring step S5; a displaying step S6; a punching-position specifying step (specifying step) S7; and a collecting step S8.

An image-processing method according to the present invention corresponds to steps from the image-acquiring step S1 to the restoring step S5.

In the image-acquiring step S1, the user observes the chip array 70 by using the optical microscope 2 and captures an image of the entire section A by using the image-acquisition portion 12 at an appropriate image-capturing magnification at which the entire divided section A is included in the viewing field of the image-acquisition portion 12. The divided-section image P acquired by the image-acquisition portion 12 is transmitted to the image-processing device 4 via the data bus 6.

Note that it is possible to employ an arbitrary method for the acquisition of the divided-section image P in the image-acquiring step S1. For example, partial images of the chip array 70 may be acquired at a high magnification, and the divided-section image P may be obtained by appropriately joining the plurality of acquired partial images.

The computation portion 15 performs the procedures from the template-creating step S2 to the displaying step S6 by executing the image-processing program.

In the template-creating step S2, the computation portion 15 creates a template to be used in the subsequent chip-recognizing step S3 on the basis of the actual size of one side of each chip 7a, the image-capturing magnification at which the divided-section image P is captured by the microscope 2, and the number of vertical and horizontal pixels in the divided-section image P. The size of one side of the chip 7a corresponds to the spacing between the grooves 8, and is, for example, input to the image-processing device 4 by the user via the input device, and is stored in the storage portion 16. The image-capturing magnification of the microscope 2 and the number of vertical and horizontal pixels of the divided-section image P are, for example, acquired from the microscope 2 by the computation portion 15 and are stored in the storage portion 16.

The image-processing device 4 calculates, on the basis of the image-capturing magnification of the microscope 2 and the number of vertical and horizontal pixels of the divided-section image P, the actual image size per pixel of the divided-section image P, and calculates, on the basis of the calculated actual image size per pixel and the actual size of one side of the chip 7a, the number of pixels corresponding to the one side of one chip 7a. Then, the image-processing device 4 creates a rectangular template in which one side thereof has the calculated number of pixels.

Next, in the chip-recognizing step S3, the computation portion 15 reads out the divided-section image P from the temporary storage device, performs pattern matching between the template and the divided-section image P, and recognizes, as chip regions R, regions in the divided-section image P that have a high correlation with the template. In pattern matching, by using the template having a shape that is substantially similar to the individual images of the chips 7a in the divided-section image P, images of rectangular dust particles or the like of different sizes other than the images of the chips 7a would not be misrecognized as the chip regions R, and thus, it is possible to accurately and quickly recognize the images of the chips 7a in the divided-section image P as the chip regions R. Here, in order to enhance the precision of pattern matching, image processing, such as grayscale binarization, thinning, outline identification, or the like, may be applied to the divided-section image P before performing pattern matching.

Next, in the attribute-information assigning step S4, the computation portion 15 assigns attribute information to all of the pixels in the divided-section image P and stores the attribute information in the storage portion 16 in association with the pixels. The attribute information includes flags (region information), the addresses (position coordinates), and the center coordinates of the chip regions R.

There are three types of flags, for example, “0”, “1”, and “2”: “1” is assigned to pixels constituting the chip regions R, “2” is assigned to pixels that are positioned at the outermost side among the pixels constituting the individual chip regions R and that constitute the outlines of the chip regions R, and “0” is assigned to pixels that constitute regions other than the chip regions R. On the basis of these flags, it is possible to judge to which region in the divided-section image P the individual pixels belong.

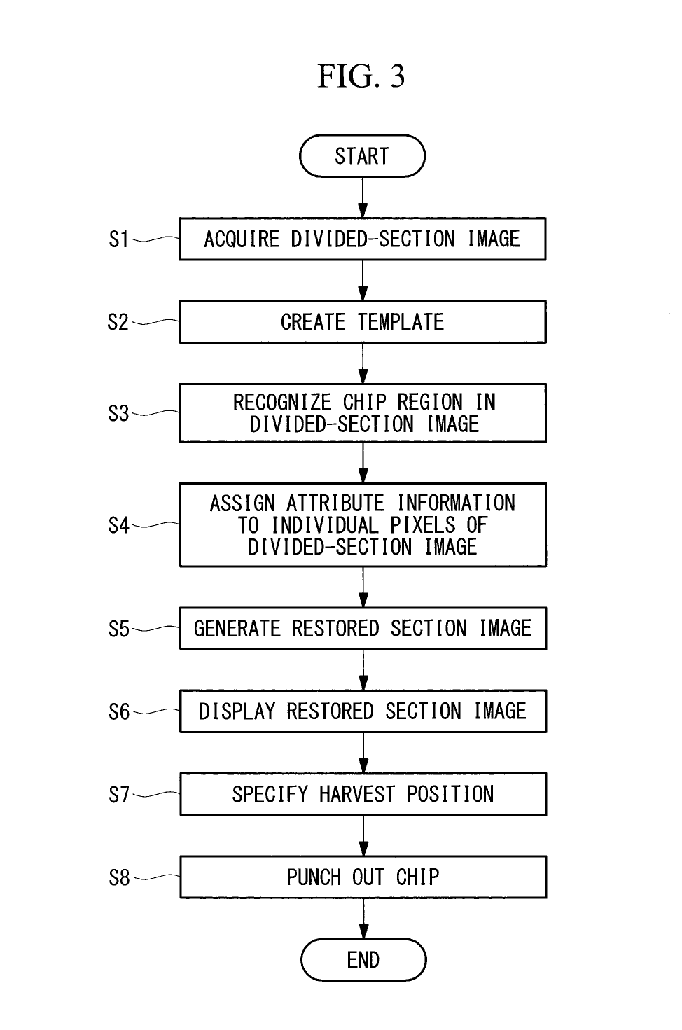

The addresses are pieces of information that indicate the positions of the individual chip regions R in the image of the chip array 70 in the divided-section image P and are defined by, for example, combinations of the row numbers A, B, C, . . . and the column numbers 1, 2, 3, . . . , as shown in FIG. 4. The addresses are assigned to the pixels to which the flag “1” or “2” has been assigned. For example, in the example shown in FIG. 4, an address “A1” is assigned to all of the pixels included in the chip region R positioned at the upper left corner of the image of the chip array 70.

The center coordinates of the chip region R are coordinates in the divided-section image P at the center position of the chip region R to which a given pixel belongs. The center coordinates of the chip regions R are calculated by the computation portion 15 on the basis of the coordinates of pixel groups that constitute the individual chip regions R.

Next, in the restoring step S5, the computation portion 15 rearranges, on the basis of the attribute information assigned to the individual pixels, the chip regions R so that the adjacent chip regions R are in contact with each other without gaps therebetween and without overlapping with each other.

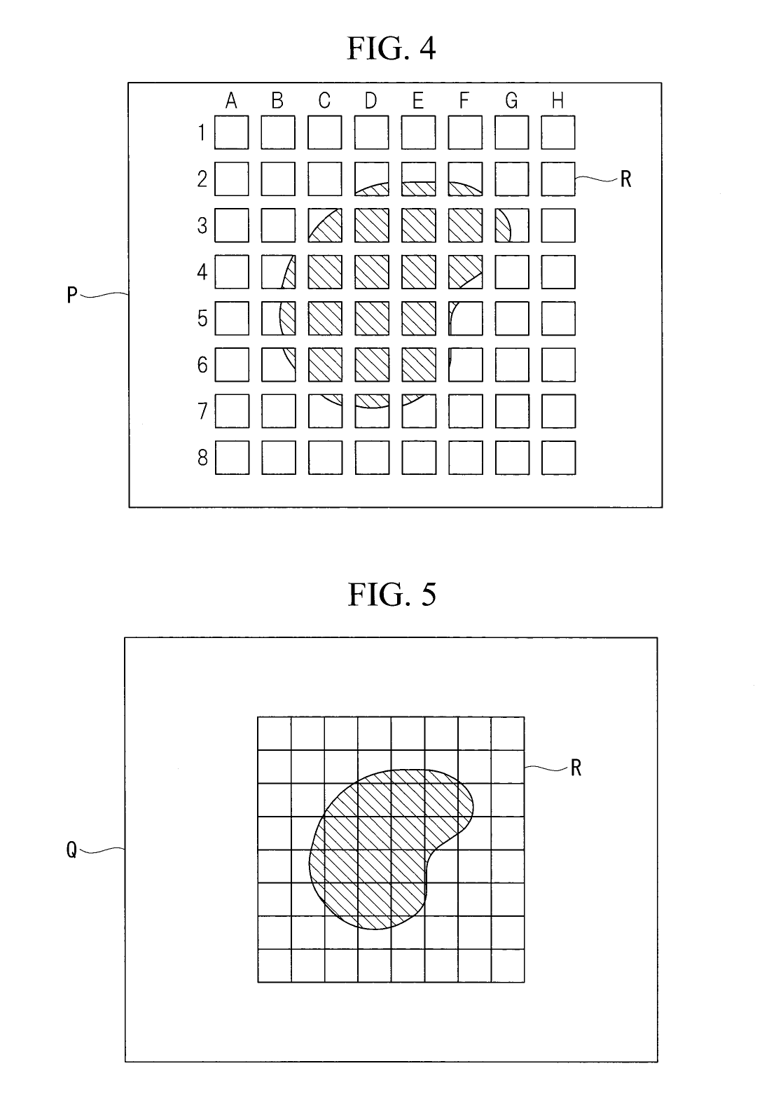

Specifically, first, the pixels to which the flag “0” has been assigned are eliminated from the divided-section image P. By doing so, only the chip regions R arrayed with spaces therebetween are left. Next, one chip region R among the plurality of chip regions R is focused on, and, so as to bring the pixels to which the flag “2” has been assigned in the focused chip region R and the pixels to which the flag “2” has been assigned in the chip regions R adjacent to the focused chip region R into direct contact with each other, the adjacent chip regions R are moved in the horizontal direction. By dong so, gaps between the chip regions R are eliminated. By repeating the horizontal movement of the adjacent chip regions R while changing the focused chip region R, as shown in FIG. 5, a restored section image Q that includes an image of the entire section A that is joined without gaps is obtained. To the individual pixels constituting the restored section image Q, the above-described flag “1” or “2”, addresses, and center coordinates of the chip regions R are assigned as the attribute information.

Next, in the displaying step S6, the generated restored section image Q is output to the display portion 5 from the computation portion 15, and the restored section image Q is displayed on the display portion 5.

Next, in the punching-position specifying step S7, the user observes the restored section image Q on the display portion 5, and specifies, by using, for example, a user interface like a touch screen (not shown), a desired position of the section A in the restored section image Q. The computation portion 15 identifies, on the basis of the address assigned to the pixel at the specified position, a chip region R that includes the pixel at the specified position from among the chip regions R in the restored section image Q and transmits the center coordinates of the identified chip region R to the punching portion 3.

Next, in the collecting step S8, the punching portion 3 computes, on the basis of the center coordinates of the chip region R received from the computation portion 15, the center position of the chip 7a to be punched out with the needle 13, moves the needle 13 to the calculated center position in the horizontal direction, and lowers the needle 13. By doing so, the chip 7a corresponding to the chip region R at the position the user has specified in the restored section image Q on the display portion 5 is punched out and falls from the sheet 9. The fallen chip 7a is recovered in a container (not shown) that is placed vertically below the stage 10 in advance.

As has been described above, with this embodiment, the individual pixels constituting the chip regions R in the divided-section image P are given the addresses that indicate to which chip region R those pixels belong, and, subsequently, a restored section image Q in which an image of the entire section A is restored by joining the chip regions R with each other is generated. The addresses also correspond to the positions of the individual chips 7a in the actual chip array 70. Therefore, there is an advantage in that it is possible to, in an accurate, simple manner, identify, in the chip array 70 in which numerous minute chips 7a are arrayed, the chip 7a corresponding to the position the user has specified in the restored section image Q on the basis of the address thereof.

Note that, in this embodiment, although a desired chip 7a is automatically collected from the chip array 70 on the basis of the position the user has specified in the restored section image Q, alternatively, the user himself/herself may manually position the needle 13 and collect the chip 7a by manipulating the holder 14.

In this case, the divided-section image P is also displayed on the display portion 5, and processing that would allow the user to visually recognize which one of the chip regions R in the divided-section image P is the chip region R corresponding to the position specified in the punching-position specifying step S7 is applied to the divided-section image P. Because the image of the chip array 70 in the divided-section image P is an image in which the actual chip array 70 is captured, it is possible for the user to easily identify to which one of the chips 7a in the actual chip array 70 the specified chip region R in the divided-section image P corresponds.

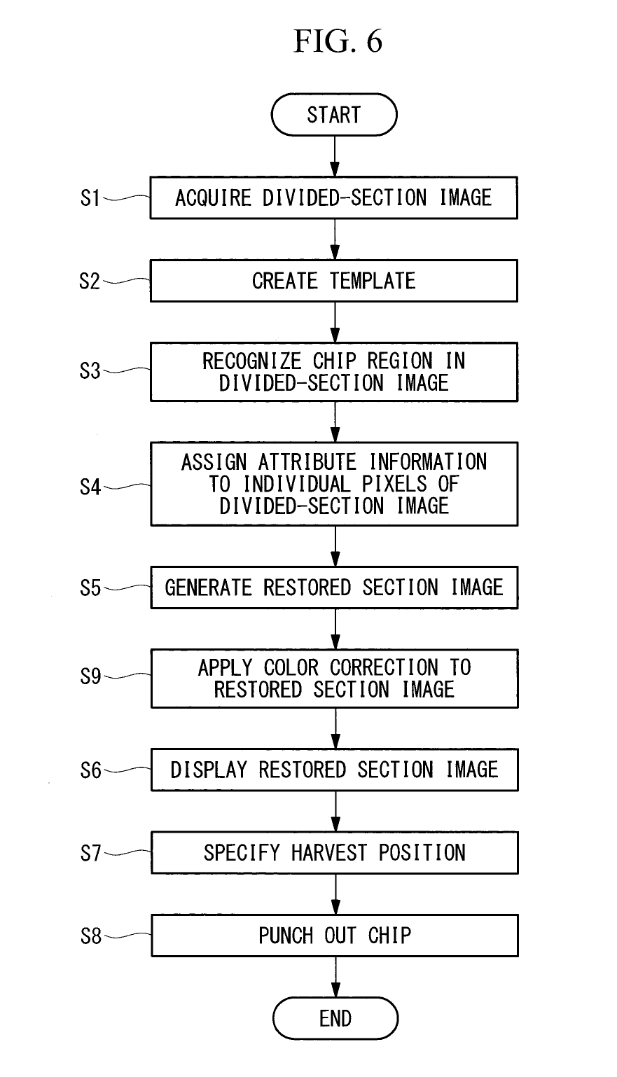

In addition, as shown in FIG. 6, this embodiment may additionally include, after the restoring step S5, a color-correcting step S9 of correcting colors of pixels positioned in boundaries between adjacent chip regions R in the restored section image Q on the basis of colors of pixels in the vicinity thereof. In this case, a color-corrected restored section image Q′ is displayed on the display portion 5 in the displaying step S6.

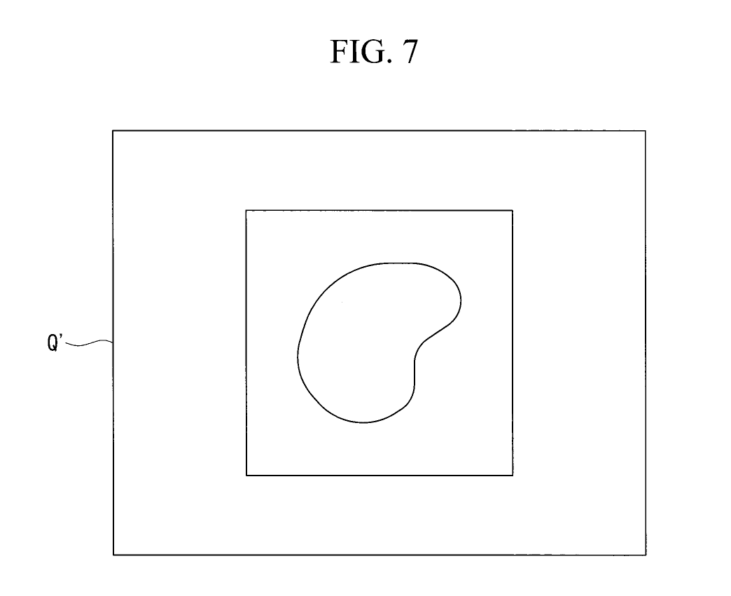

In the restored section image Q generated in the restoring step S5, in a boundary between two adjacent chip regions R, two pixels (hereinafter, also referred to as boundary pixels) to which the flag “2” has been assigned are arranged next to each other. In the color-correcting step S9, the computation portion 15 corrects the colors of such two (a pair of) boundary pixels, on the basis of the colors (hue, brightness, and saturation) of pixels positioned on either side of the two (the pair of) boundary pixels in the arraying direction. For example, the computation portion 15 assigns the average color of the colors of the pixels on either side of the two (the pair of) boundary pixels or the color that is the same as that of the pixel on one side to the boundary pixels. The computation portion 15 applies the color correction, in the same manner, to all of the two (the pair of) boundary pixels positioned on boundaries between two adjacent chip regions R. By doing so, the colors of the restored section image Q are locally corrected so as to be smoothly continuous, bridging the boundaries therein, and thus, there is an advantage in that it is possible to obtain a restored section image Q′ in which boundaries among the chip regions R are inconspicuous, as shown in FIG. 7. Note that the color correction may be applied not only to the boundary pixels but also to pixels in the vicinity of the boundary pixels, as needed.

The above-described embodiment leads to the following invention.

A first aspect of the present invention is an image-processing method with which an image of a chip array in which numerous chips, which are obtained by dividing a substrate to which a section of biological tissue is attached together with the section, are two-dimensionally arrayed with spaces between the chips, the image-processing method including: an image-acquiring step of acquiring a divided-section image that includes the entire divided section by capturing an image of the chip array; a chip-recognizing step of recognizing chip images in the divided-section image acquired in the image-acquiring step; an attribute-information assigning step of assigning, to each of pixels that constitute the chip images recognized in the chip-recognizing step, attribute information that includes positional information of the chip images to which those pixels belong in the image of the chip array; and a restoring step of generating a restored section image in which images of the divided section are joined into a single image by joining the chip images constituted of the pixels to which the attribute information has been assigned in the attribute-information assigning step.

With the first aspect of the present invention, the chip images in the divided-section image acquired in the image-acquiring step are recognized in the chip-recognizing step, in the restoring step, the chip images are combined with each other into a single image without gaps therebetween and without overlapping with each other, and thus generating the restored section image including the image of the entire section before the division. In the restored section image, it is possible to accurately ascertain the tissue structure, cell distribution, or the like in the section. Therefore, the user can appropriately select, on the basis of the restored section image, a position which should be harvested from the section.

In this case, in the attribute-information assigning step, the individual pixels that constitute the restored section image are given, as the attribute information, the positional information that indicates the positions of the chips in the chip array to which those pixels correspond. Therefore, on the basis of the positional information of a pixel at the position which should be harvested in the restored section image, it is possible to easily and accurately identify which one of the chips in the divided-section image is the chip to be collected. Then, by comparing the image of the chip-array in the divided-section image with the actual chip array, it is possible to easily identify a desired chip even among the numerous minute chips.

The above-described first aspect may include a color-correcting step of correcting, at a boundary of the chip images adjacent to each other in the restored section image, colors of pixels that are adjacent to each other on either side of the boundary on the basis of colors of pixels in the vicinity of these pixels.

In the restored section image, the boundaries between the chip images tend to be conspicuous due to burrs or the like created along the dividing lines when dividing the substrate together with the section. Therefore, by correcting the colors of the pixels positioned in the boundaries so as to have the same or similar colors as those of the pixels in the surrounding areas thereof, it is possible to restore a more natural image of the entire section before the division in which the boundaries between the chip images are inconspicuous.

In the above-described first aspect, in the attribute-information assigning step, region information that indicates whether or not a given pixel is a pixel that constitutes the chip images may be assigned, as the attribute information, to all of the pixels constituting the divided-section image, and, in the restoring step, pixels that do not constitute the chip images may be eliminated on the basis of the region information, and the restored section image may be generated by joining the remaining pixels that constitute the chip images with each other.

By doing so, it is possible to generate a restored image by means of a simple processing.

A second aspect of the present invention is a cell-sorting method including: any one of the above-described image-processing method; a displaying step of displaying the restored section image; a specifying step of specifying, in the restored section image displayed in the displaying step, a position which should be harvested from the section; and a collecting step of collecting the chip from the chip array on the basis of the positional information assigned to a pixel corresponding to the position specified in the specifying step.

With the second aspect of the present invention, on the basis of the positional information of the pixels at the position specified in the specifying step, it is possible to easily identify the chip that should be collected from the actual chip array, and it is possible to collect the identified chip in the collecting step.

### REFERENCE SIGNS LIST

1 cell-sorting system
2 optical microscope
3 punching portion
4 image-processing device
5 display portion
6 data bus
7 substrate
7a chip
70 chip array
8 groove
9 sheet
10 stage
10a window
11 objective lens
12 image-acquisition portion
13 needle
13a needle tip
14 holder
15 computation portion
16 storage portion
A section
P divided-section image
Q restored section image
S1 image-acquiring step
S2 template-creating step
S3 chip-recognizing step
S4 attribute-information assigning step
S5 restoring step
S6 displaying step
S7 punching-position specifying step (specifying step)
S8 collecting step
S9 color-correcting step

1. An image-processing method with which an image of a chip array in which numerous chips, which are obtained by dividing a substrate to which a section of biological tissue is attached together with the section, are two-dimensionally arrayed with spaces between the chips, the image-processing method comprising:
an image-acquiring step of acquiring a divided-section image that includes the entire divided section by capturing an image of the chip array;
a chip-recognizing step of recognizing chip images in the divided-section image acquired in the image-acquiring step;
an attribute-information assigning step of assigning, to each of pixels that constitute the chip images recognized in the chip-recognizing step, attribute information that includes positional information of the chip images to which those pixels belong in the image of the chip array; and
a restoring step of generating a restored section image in which images of the divided section are joined into a single image by joining the chip images constituted of the pixels to which the attribute information has been assigned in the attribute-information assigning step.

2. An image-processing method according to claim 1, further comprising:
a color-correcting step of correcting, at a boundary of the chip images adjacent to each other in the restored section image, colors of pixels that are adjacent to each other on either side of the boundary on the basis of colors of pixels in the vicinity of these pixels.

3. An image-processing method according to claim 1,
wherein, in the attribute-information assigning step, region information that indicates whether or not a given pixel is a pixel that constitutes the chip images is assigned, as the attribute information, to all of the pixels constituting the divided-section image, and,
in the restoring step, pixels that do not constitute the chip images are eliminated on the basis of the region information, and the restored section image is generated by joining the remaining pixels that constitute the chip images with each other.

4. A cell-sorting method comprising:
an image-processing method according to claim 1;
a displaying step of displaying the restored section image;
a specifying step of specifying, in the restored section image displayed in the displaying step, a position which should be harvested from the section; and
a collecting step of collecting the chip from the chip array on the basis of the positional information assigned to a pixel corresponding to the position specified in the specifying step.
